(19) United States
(12) Patent Application Publication
(10) Pub. No.: US 2003/0116154 A1
(43) Pub. Date: Jun. 26, 2003

(54) Method and system for controlling a solar collector

(76) Inventors: Barry Lynn Butler, Solana Beach, CA (US); Roger Lee Davenport, Golden, CO (US)

Correspondence Address: KILPATRICK STOCKTON LLP, 607 14TH STREET, N.W., SUITE 900, WASHINGTON, DC, 20005, US

(21) Appl. No.: 09/887,631

(22) Filed: Jun. 22, 2001

(51) Int. Cl. F24J 2/40; F03G 6/00

(52) U.S. Cl. 126/569; 126/570; 126/574; 60/641.8

(57) ABSTRACT

A method and system for controlling a solar collector is disclosed. A microprocessor receives inputs from one or more sensors in a solar collector and determines the state of the solar collector from the inputs. Commands are also received from an external source for controlling operation of the solar collector. The microprocessor executes instructions to complete the command based on the state of the solar collector.

### FIELD OF THE INVENTION

The invention relates to a system and method for controlling a solar collector. More specifically, the method relates to a controller system and associated software for accepting sensor inputs from sensors on the solar collector to determine the state of the solar collector, issuing commands to control the orientation of the solar collector, and executing instructions based on the collector state.

### BACKGROUND OF THE INVENTION

Solar collector systems are used to collect solar energy from sunlight and convert it to a usable form of energy. The terms “solar collector,” “collector,” and “solar dish” or “dish” are used interchangeably herein to indicate the collector portion of the solar collector, although, as would be understood by one of ordinary skill in the art, a solar collector is not necessarily dish-like in shape.

One example of converting solar energy to usable energy is that solar energy may be stored in a battery for future use, or it may be used to generate power using a solid state device or an engine system. Such devices are referred to herein as a Power Conversion System (“PCS”). One such engine system commonly used in solar collector systems is a Stirling engine, which is a type of engine that derives mechanical power from the expansion of a confined gas at a high temperature. However, the system and method disclosed herein may be adapted for use with any PCS.

Solar collector systems typically include motion controlling systems to change the orientation of the collector. As the sun moves across the sky, the solar collector orientation must be changed accordingly to track the position of the sun by compensating for the earth's rotation. One complication arising from the use of solar collection is that high wind conditions may cause damage to solar collector systems because solar collectors are typically placed on a pedestal above the ground. Therefore, to avoid such damage, the solar collector is normally lowered or stowed in a safer orientation if high wind conditions exist.

The motors and drive systems used to control the orientation of a solar collector system may be controlled electronically by some combination of manual commands entered by a user. Alternatively, sensors may be placed to monitor various conditions of the solar collector, and a microprocessor may issue commands to change the orientation of the solar collector system based on the sensor inputs.

Current programming techniques used on such microprocessors are based on a hierarchical methodology. As used herein, the terms “program algorithm,” “program routine,” “program subroutine,” “algorithm,” “routine,” and “subroutine” are used interchangeably to refer to any block of code that may be logically grouped together and may or may not use the conventional subroutine interfaces as defined by typical programming languages. As would be understood by one of ordinary skill in the art, a program routine or subroutine is generally understood as a stylistic convention of programming, and thus different routines or subroutines may be written in multiple combinations and accomplish the same function. Thus, as used herein, a program algorithm, routine or subroutine encompasses any block of code logically grouped together regardless of whether conventional subroutine interfaces, as defined by typical programming languages, are used.

In a hierarchical program, the programming algorithm operates in a sequential manner, and the orientation of the solar collector is known to a system operating in accordance with the algorithm, based on previously issued commands. For example, the programming algorithm is initialized to certain starting parameters to indicate the starting orientation of the solar collector. If a user enters a command to place the solar collector into an operational state, the system implementing the programming algorithm issues instructions to the motors and drive systems to move a given direction in order to be placed in operational orientation. If the solar collector is moved again, for example, to track the sun, the information from the previously executed commands is used to determine what commands must be issued to re-orient the solar collector. By “state” or “collector state” is meant the combination of all the known status indicators of the collector, which may include positional orientation, temperature, wind conditions, etc.

If an error in the system occurs, it is difficult or impossible to issue new commands correctly. That is, if the program implementing the algorithm is unable to determine the correct orientation of the solar collector from its past history, it cannot accurately issue new commands or instructions. Error detection is also difficult in such a system. If the program implementing the algorithm has an error, it will continue to operate even though it may be issuing commands based on incorrect assumptions about the solar collector orientation. If such a system is turned off and restarted in mid-operation, the program routine does not have correct starting parameters, and therefore, is unable to issue correct control commands.

These and other problems are avoided by the method and system described herein, and numerous advantages are provided, as will become apparent from the following discussion.

### SUMMARY OF THE INVENTION

In one aspect, the invention is directed to a method for controlling a solar collector. A microprocessor is configured for receiving inputs from one or more sensors on and/or around the solar collector, i.e., generally associated with the solar collector. The inputs received by the microprocessor correspond to a solar collector state. Commands are received by the microprocessor from an external source for controlling the operation of the solar collector. The microprocessor runs a program routine for completing the command based on the previously determined state of the solar collector. Preferably, the program routine executes default instructions to place the solar collector in a default position if the state of the solar collector is not a known state corresponding with a command. If the state of the solar collector is not a known state corresponding with the command, the program routine preferably issues an error message to alert a user of the unknown state.

In another aspect, the invention is directed to a system for controlling a solar collector. A solar collector system for converting solar energy is operatively connected to a focusing device. One or more sensors are located on or around the solar collector system. One or more motor assemblies are in communication with the solar collector system for positioning the solar collector system. A microprocessor is configured for receiving inputs from the sensors, determining the state of the solar collector from the inputs, receiving a command from an external source, and executing instructions to complete the command based on the state of the solar collector. A power box is in communication with the solar collector system and the microprocessor. The power box includes a device for monitoring the power output of the solar collector system and a dish controller. The dish controller includes inputs connectable to the sensors, an input connectable to the device for monitoring the power output of the solar collector system, a communication cable for exchanging information between the dish controller and the computer system, and outputs. The power box also includes an output board, which is in communication with the dish controller and includes outputs to the motor assemblies and outputs to the focusing device. The power box also includes one or more uninterruptible power supplies for powering controls to a device for storing the usable energy and to the dish controller, and a power meter for monitoring the usable energy produced by the solar collector system.

Because the instructions issued by the microprocessor are based on the current state of the collector system, the program routine does not rely on the previous history of instructions or conditions to issue commands. Therefore, the entire system may be shut down and turned back on and function correctly without the need to manually restart the system from initial starting parameters. Errors are detected more readily because unknown or unrecognized states are immediately flagged to a user. Preferably, if an unknown or unrecognized state occurs, default commands may be issued to stow the collector in a safe, shut-down position.

These and other advantages will become apparent to those of ordinary skill in the art from the following the detailed description made with reference to the appended drawings.

### BRIEF DESCRIPTION OF THE DRAWINGS

FIG. 1 is a block diagram of an exemplary solar collector system.

FIG. 2 is a block diagram of a power box used with the system.

FIG. 3 is a block diagram of the dish controller and output board of the system.

FIG. 4 is a block diagram of the drive assembly cabling for the system.

FIG. 5 is a diagram of the truth table operation which illustrates operation of the system.

### DETAILED DESCRIPTION OF THE INVENTION

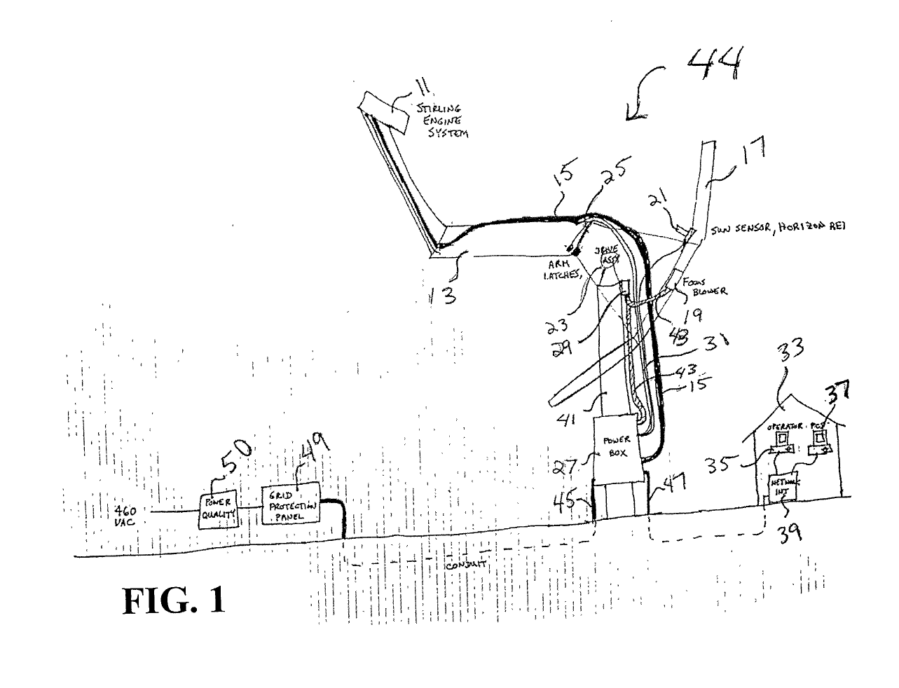

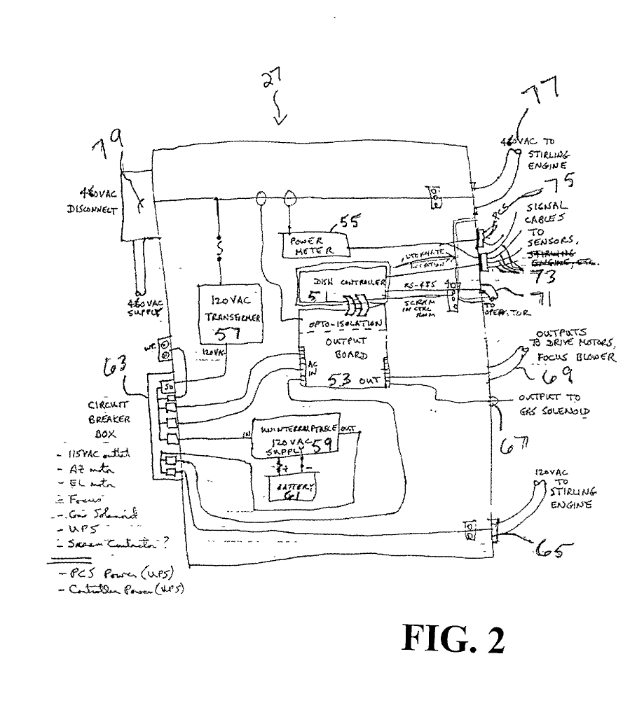

FIG. 1 is a block diagram of an exemplary solar collection system implementing the system and method described herein. A collection assembly 44 includes a solar collector dish 17 which is supported by a pedestal 41. The solar collector dish 17 has a focusing device 19 for focusing sunlight to the solar collector dish 17. The solar collector dish 17 is a system of solar collectors which focuses and collects solar energy. The focusing device 19 manipulates the solar collectors on the solar collector dish 17 to further fine tune the focusing of the collectors. The focusing device 19 may be a focus blower or oscillator or other equivalent device. Heat from the solar energy is converted to a usable form by a Stirling engine system 11, which is supported by a support arm 13 and attached to the power box 27 by a cable 15. The power box is described in more detail in the discussion making reference to FIG. 2.

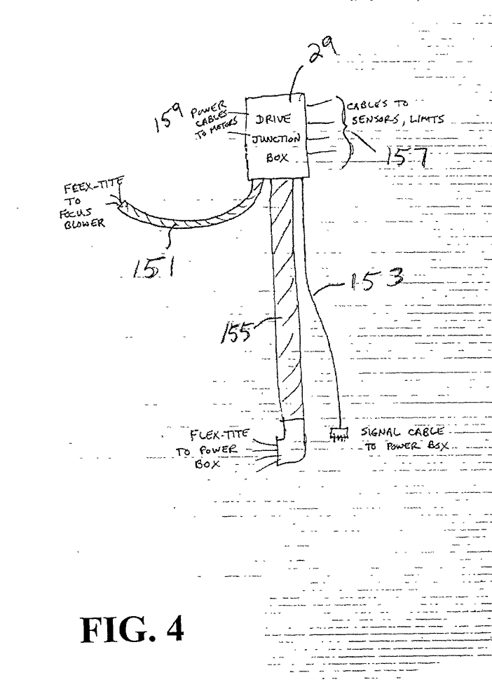

A drive assembly 23 and arm latches 25 control motion and orientation of the dish 17 and Stirling engine 11 with respect to elevation and azimuth. As discussed previously, a Stirling engine is a type of Power Conversion System (“PCS”). A drive junction box 29, described in more detail in the discussion accompanying FIG. 4, is connected to the focusing device 19 and the power box 27 by cables 43. Sensors are placed at various locations on and around the solar collector dish 17, i.e., in association with the collector dish 17. Examples of such sensors are a sun sensor and horizontal reference sensor 21, which are shown in FIG. 1. Various other sensors may be placed on and around the dish 17, and are connected by cables 31 to the power box 27. Energy in the form of usable electricity is transferred from the power box 27 by a cable 45 through a grid protection panel 49 and through a power quality control box 50 eventuated for use by energy consumers.

The power box 27 is also connected to a computer system at a user's station 33 by a cable 47. The computer system at the user's station 33 may include an operator terminal 35 for entering commands and a Stirling Power Conversion System (“PCS”) processor terminal 37 connected by a network 39 for communication with the collection assembly 44. The computer system 35, 27, and 39 communicates and controls the orientation of the solar collector assembly 44.

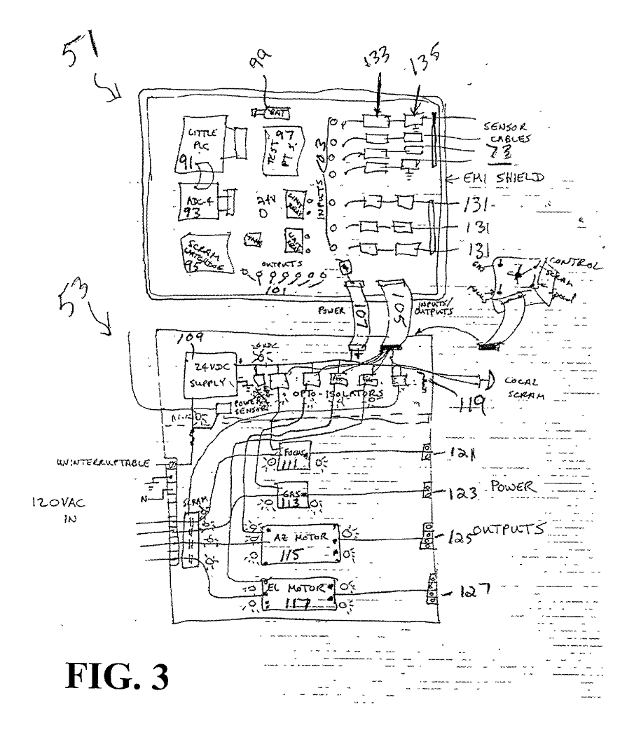

FIG. 2 is a block diagram showing in greater detail the power box 27. The power box 27 is connected to the Sirling engine by connections 77 and 65, to the sensors (21 in FIG. 1) by connections 75, to the PCS terminal (37 in FIG. 1) by connections 75, to the operator terminal (35 in FIG. 1) by connections 71, to drive motors and the focusing device (19 in FIG. 1) by connections 69, and to a gas solenoid by connection 67. The gas solenoid (not shown) opens a valve to provide fuel gas to the system for gas-fired hybrid power production, if desired. Otherwise, electricity powers operation of the system directly. The power box 27 has a connection from the Stirling engine to an output 79. The power box 27 monitors the Stirling engine and associated sensors with a power meter 55. The power box 27 also contains a dish controller 51 and output board 53, which are described in more detail in the discussion accompanying FIG. 3.

The power box 27 has an uninterruptible power supply 59 connected to a battery 61 for supplying power to the entire assembly (44 in FIG. 1). Therefore, the control system can continue to operate even if it is not receiving solar power. The power box 27 contains a circuit breaker box 63 to protect the electronics from power surges. The power box 27 may also include a transformer 57.

In one embodiment, the power box 27 includes a manual 460 volt alternating current (“VAC”) disconnect 79 from the utility grid 49 (FIG. 1), a 460VAC to 115VAC transformer 57, a 115VAC uninterruptible power supply 59 for the Stirling engine controls and for the dish controller 51, a 24 volt direct current (“VDC”) control power supply, a battery 61 for powering the uninterruptible power supply, a device for monitoring the power output of the system as an input to a controller, relays for dish control outputs, the dish controller component 51. In another embodiment the power box 27 includes an inverter device for inverting direct current electrical power to alternating current.

FIG. 3 is a block diagram of the dish controller 57 and output board 53. The dish controller 57 has sensor cable inputs 73 and communication lines 131, which connect to the Stirling engine, the user terminal, and manual controls. The dish controller 57 may be powered by a battery 99, which may serve as a backup power supply. The sensor cable inputs 73 and communication lines 131 include buffers/opto-isolation chips 133, of the type well-known to those of ordinary skill, and varistors 135 for protecting the electronics from power surges and lightning strikes.

The cables 73 and 131 are connected to light emitting diodes (“LEDs”) inputs 103. Test points 97 provides a point where a technician may test the electronics. The dish controller 57 includes a programmable logic controller (“PLC”) 91 connected to an analog to digital converter (“ADC”) 93. A “SCRAM switch” 95, of the type well known to those of ordinary skill, is provided as an emergency shut-off switch.

The inputs 103 and outputs 101 of the dish controller 57 have status lights (off=0, on=1) to display the respective states, i.e., on or off, and are connected by a connection 105 to the output board 53. The inputs and outputs can be easily read by a service technician. The dish controller also receives power from a power supply 109 in the output board 53 through a power cable 107. Opto-isolators 119 provide power surge protection. The outputs 101 from the dish controller 57 control the orientation of the solar collector through a controller for the focusing device 111, a first controller 113 for the gas solenoid, a second controller 115 for the azimuth motor, and a third controller 117 for the elevation motor. Controllers 111, 113, 115, and 117 are connected to power outputs 112, 123, 125, and 127 for powering the focusing device, gas solenoid, azimuth and elevation motors (not shown in detail).

In one embodiment, the dish controller 51 is a board that uses signal-level voltages (24VDC or less) and performs input and output signal processing and computed control functions. It may be mounted in a box within the power box 27 or in a separate enclosure in communication with the power box 27.

FIG. 4 is a block diagram illustrating the drive assembly cabling. A drive junction box 29 connects cables to the sensors 157 and cables to the various motors in the system 159. A connection 151 is also provided to the focusing device, as are connections 155 to the power box, and a signal cable connection 153 to the power box.

The control software is run from the PLC 91 shown in FIG. 3 as part of the dish controller 57. The program implementing the algorithms receives inputs from one or more sensors in and around the solar collector; determines the state of the solar collector from the inputs; receives a command from an external source for controlling operation of the solar collector; and executes instructions to complete the command based on the state of the solar collector. The program implements a truth table to map a set of instructions to each unique set of conditions. Certain conditions may also trigger a “system override,” which shuts the system down. The commands may originate from the user at the operator terminal 35 or the commands may be generated by a detected set of conditions. An example of a truth table is shown in Table 1 in the Program Routine Example, which follows hereafter.

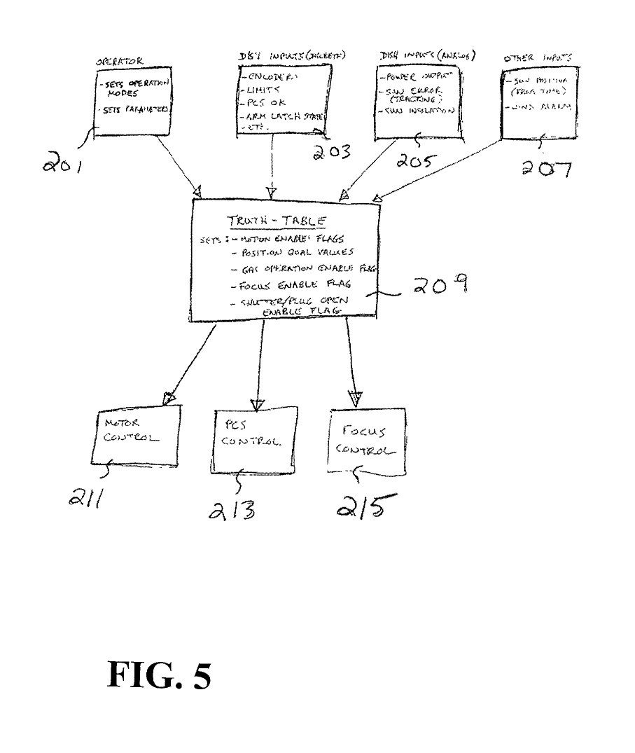

FIG. 5 is a diagram of an example of a truth table operation. Inputs are received from four categories of information. At block 201, inputs are received from the operator terminal to set operation modes and set the parameters of operation. At block 203, inputs are received from digital dish inputs regarding information about encoders, limits, the PCS, the arm latch state, etc. At block 205, analog dish inputs are received regarding information such as power output, sun error (tracking), and sun insolation. At block 207, other inputs such as sun position and wind alarm are received.

Block 209 represents the truth table. The truth table sets flags corresponding to a unique set of instructions. Examples of flags include the motion enable flags, the position goal values, the gas operation enable flag, the focus enable flag, and the shutter/plug open enable flag. The flags are set based on the states received from blocks 201, 203, 205, and 207. The flags and the position goal values correspond to a unique set of instructions which are transferred from the truth table 209 to motor controls 211, PCS controls 213, and focus controls 215.

The truth table may be implemented in a variety of environments, including commercially available computer systems, programmable gate arrays, and microprocessor chips.

### PROGRAM ROUTINE AND ENVIRONMENT EXAMPLE

The following example of the program routine and the environment in which the program routine is run is provided to illustrate an embodiment of the invention.

The software preferably operates in the real-time Dynamic C programming environment on a Z-World Little PLC microcontroller. Such a controller uses a Z180 processor, and has 128K Bytes of battery-backed static random access memory (RAM) in which the program and data reside. The controller has eight digital inputs, and eight outputs capable of directly driving relays. An expansion board (e.g., Z-World ADC-4) provides an additional four conditioned and seven unconditioned analog inputs with a 12-bit A-to-D converter. The Little PLC also includes a real-time clock and two RS-485 simplex (two-wire) serial communications ports. One of these ports are used to communicate with a central supervisory control and data acquisition (SCADA) system, shown in FIG. 1, as user terminal 35 and network 39, and the other port is used to communicate with the Stirling Power Conversion System (PCS) processor shown as PCS terminal 37 in FIG. 1.

The control software operates a solar collector system 44 as shown in FIG. 1 in a stand-alone manner, including solar operation and operation on fuel, such as gas, direct electrical power from an electrical distribution system or and/or other alternative energy source. The system communicates with the external supervisory control and data acquisition, “SCADA,” system that operates over a daisy-chain network to provide user input and display of system parameters, data downloads, and overall system control multiple solar collector systems 44. The SCADA system also incorporates a wind sensor (not shown), and tells the solar collector systems 44 on the network when the wind exceeds allowable limits.

Solar operation is controlled with both calculated and sensor inputs. A sun position algorithm calculates the expected position of the sun. A sun sensor provides information about the relative position of the dish to the sun, as well as measuring the total solar insolation. The insolation sensor allows decisions to be made regarding whether to use the sun sensor directions and whether net power can be generated. Finally, a tracking optimization algorithm allows the system to track the aim point at which peak power is generated.

Operation on gas is allowed independent of solar operation. When solar operation is disabled or the sun is insufficient for net power generation on solar, a shutter/plug is kept closed in front of the receiver to maximize efficiency for fuel operation.

The overall architecture of the control program is that of a set of real-time interrupt-driven background tasks and a set of foreground tasks that operate in an endless loop. The real-time tasks are devoted to measurement and control of the high-frequency components of the control system. These consist of encoder signals from the system drive motors, used to calculate the dish position in real time, and the control of the drive motors. The foreground loop consists of several parallel tasks that cooperatively multi-task to perform all of the other control actions needed by the system.

The controlling element in the system is the truth-table function, which implements the program algorithm. This function takes as its inputs the values of a set of system flags that uniquely determine the status and operating mode of the system. The flags consist of overrides, system control flags, and system status flags. The outputs from the function include a function to enable flags for motion, focus, and running on gas, and goal values for the azimuth and elevation of the dish. The outputs are processed by other functions to control movement and operation of the system.

In addition, there are three system override flags. They override any other system operations. The override flags are as follows:

local The system is under local control at the pedestal. This is triggered when the power output cable containing the motor and focus power lines is disconnected from the controller. It leads to disabling of movement and focus outputs, but allows operation to resume when the cable is re-attached.

high_wind This flag is set when the SCADA system measures winds exceeding the stow threshold, and commands the system to stow. It leads to shutdown of solar operation and stowing of the dish in a face-up position feathered 90 degrees to the wind, or a face-down position, whichever is closer. After the high wind subsides, the system is allowed to return to solar operation. The system may continue to be powered with fuel during a high-wind stow.

fault This is triggered whenever a fault occurs in the system. It leads to shutdown of solar and fuel operation, and stowing of the dish until the fault is reset from the SCADA system. The fault flag is bit-mapped, with the following bit values:

1 Failure of the latch on the support arm to unlatch when going to stow

2 Azimuth motor fault—either the motor did not move when commanded, or it moved when not commanded

3 Elevation motor fault—same as Azimuth motor fault

4 PCS fault—loss of “PCS Ready” indication (either the physical switch closure or the serial status)

5 focus power fault—power was detected to the focusing device when it was commanded to be off

6 plug fault—the plug failed to open when the dish was focused

7 PCS communications fault—the PCS failed to respond to status requests

There are three main system control flags, and two auxiliary control flags that only have an effect when the system is in local control. The three main control flags are set via the supervisory control and data acquisition, “SCADA,” system; the auxiliary flags are set in response to physical switch closures in the local control pendant. The flags are as follows:

run_solar This flag enables solar operation. When enabled, the system automatically wakes itself, generates power when the solar insolation is high enough, and stows itself at night or if high winds occur.

run_gas This flag enables operation on fuel. When enabled, the Stirling Power Conversion System (PCS) is told to run on gas. Unless solar operation is enabled and the system is focused, the aperture plug is kept closed.

track_mode This flag determines the mode in which the system will track the sun when solar operation is enabled. The four modes are as follows:

0 sun sensor—the sun sensor directions are used to direct the dish. If the insolation is insufficient, the system reverts to the calculated sun position for tracking.

1 calculated sun position—the calculated position of the sun is used for tracking

2 optimized tracking—previously determined offsets (as a function of the azimuth and elevation position of the dish) from the sun position are used for tracking.

These offsets position the dish to produce maximum net power.

3 tracking calibration—system tracking is adjusted to produce maximum net power output, and the offsets from the sun position are stored for later use in tracking mode 2.

local_open_plug This flag is set in response to a switch closure on the local control pendant calling for the plug to be opened

local_run_gas This flag is set in response to a switch closure on the local control pendant calling for the PCS to run on fuel.

System Commands

System commands are used to enable and control the system functions of the dish. All system commands used herein begin with the letter “S”.

The commands and their mneumonics are as follows:

SW n High “W”ind—the wind has exceeded the maximum operational setpoint, and is coming from direction “n” (0-15, for 0 to 360 degrees azimuth). This command may be entered manually, but is also sent automatically from the network controller to each dish on the network if high winds are detected.

SL “L”ow wind—the wind has dropped below the high-wind setpoint. This command may be entered manually, but is also sent automatically from the network controller to each dish on the network when high winds cease.

SR Enable solar operation (i.e., “R”un on solar)

SD “D”isable solar operation

SG Enable “G”as (fuel) operation

SN Disable gas (fuel) operation (i.e., “N”o gas)

ST “T”rack using the calculated sun position

SS Track using the “S”un sensor

SO Track using “O”ptimized tracking offsets

SC Perform tracking “C”alibration to maximize power output

SA n Adjust the “A”zimuth position of the dish by approximately “n” hundredths of a degree (used for debugging)

SE n Adjust the “E”levation position of the dish by approximately “n” hundredths of a degree (used for debugging)

SX Adjust the dish position to be on-sun (i.e, “X” marks the spot?)

Parameter Setting Commands

An operator may enter parameter commands to the operator terminal 35 as shown in FIG. 1. Operation of a Solar collector system involves many parameters that will vary from system to system. Parameter commands allow any of the parameter values to be examined or updated. Examples of parameters include the following:

Azimuth stow position (degrees from true North)

Elevation stow position (degrees above/below horizon)

Wind stow position (degrees above horizon)

Latitude of the system (degrees)

Longitude of the system (degrees)

Number of hours between local time and Greenwich Mean Time

Data Commands

Data commands allow the user access to the performance and other data stored by the control program during its operation. A system log is available that details the last several seconds of truth-table operation, giving inputs and outputs from the truth-table. This is mainly useful for debugging of system operation. The performance data log contains information about system operation and energy production. Both the frequency of sampling and the number of data samples that are averaged together for each recorded data point may be set by the user. An instantaneous status command gives the present conditions and mode of operation for the dish. Finally, the offset table from tracking calibration can be downloaded for examination and possible off-line processing

Inputs and Outputs

System Inputs

The Little PLC has eight opto-isolated digital inputs, and the addition of the ADC-4 board adds four conditioned and seven unconditioned analog inputs. These are connected as follows:

Little PLC Inputs:

0 Azimuth encoder channel 1

1 Azimuth encoder channel 2 (quadrature, giving direction, East or West)

2 Elevation encoder channel 1

3 Elevation encoder channel 2 (quadrature, giving direction, Up or Down)

4 local/auto—this contact is closed by shorting pins on the plug of the cable that provides AC power to the drive motors, focusing device, and PCS. It indicates local operation of the system when that cable is unplugged from the control board.

5 Azimuth limit switch

6 Elevation limit switch

7 PCS arm unlatch switch—tells the controller if the PCS arm unlatched successfully when driving to stow

ADC-4 Analog Inputs:

0 Azimuth error from sun sensor

1 Elevation error from sun sensor

2 Solar insolation reference sensor

3 System power output

4 Ambient temperature sensor

5 Relative humidity sensor

6 PCS_ready switch closure from PCS (used as a digital input)

7 Below_horizon switch closure from tilt switch (used as a digital input)

8 Focus power sensing—detects power to focusing device (used as a digital input)

9 Local_open_plug—switch closure on local pendant to request manual opening of plug (used as as digital input)

10 Local_run_gas—switch closure on local pendant to request manual operation on fuel (used as a digital input)

System Outputs

The eight outputs of the Little PLC are used to control the direction and operation of the drive motors and to actuate the focusing device. The outputs are as follows:

1 Azimuth motor run

2 Azimuth direction (energize to go East; default is West)

3 not used

4 Elevation motor run

5 Elevation direction (energize to go Up; default is Down)

6 not used

7 Focusing device on (to focus dish)

8 Gas valve open (for running on gas)

Processing Inputs and Outputs

If the system is being started for the first time, a program routine initializes the data and system logs, and initializes some variables that will keep the system from taking off when it starts. The dish is told it is at a stow position, so that until it is initialized it will not move.

The next program routine initializes other variables and parameters so that their states are not undetermined when the program begins its loop. Variables and status flags are set to nominal values.

Finally, the system enters an infinite loop in which all of the foreground functions are accomplished. A “costate” construct is a function that allows cooperative multi-tasking between functions in the loop. Each time through the loop, each costate is processed in turn. If a “waitforo” function is encountered in a costate, the processor skips that costate from then on until the allotted time has passed. This allows the costates to allow other functions to operate.

One costate processes communications with the SCADA system. The SCADA system communicates with the solar collectors in the network using a protocol that provides error checking and addressing of commands to specific controllers within the network.

A second costate contains the truth-table function evaluation. Before evaluation of the truth table, the input states are stored in the system log. Immediately after the truth table evaluation, the output results are stored in another log. The log data is stored in a circular buffer format, so that the latest data always overwrites the oldest data in the array. Other functions are allowed to operate between execution of the truth table function.

The following table summarizes other costates in the system.

focus Controls focusing of the dish. Sets the “focused” flag.

PCS Controls interaction with the PCS. This includes prompting the PCS for status and sending requests for actions such as opening and closing the aperture plug.

orientation Updates the dish orientation using the motor counts that are updated by a background function.

get_inputs Updates the input values and related variables and flags

sun_az_el Calculates the sun position at the present time

The final costate in the program routine performs performance data averaging and tracking calibration, if that mode is enabled. System output power and insolation values are sampled every “sample_period” seconds (preferably a default 5 seconds), and summed over a number of samples set by the user (preferably a default 60 samples, resulting in 5-minute averages) to obtain averages, and a program routine to load data is called to place the averaged values into the system performance data file.

The processing of the various inputs resulting in the outputs described herein is controlled by a truth table. An example of a truth table is shown, as noted previously, by the following Table 1. The input values are described at the top of the truth table. Each row of values corresponds to a unique state, which in turn corresponds to a unique set of instructions to be issued to the solar collector system 44. The “allowed dish control states” indicate when a state is required for a given command. If a command is issued and the required state is not the state indicated by the table, the software program detects the error and issues a default set of commands.

[image]

[image]

[image]

[image]

[image]

[image]

[image]

[image]

[image]

[image]

In general, fault and override conditions lead to the system shutting down and stowing. If the system is focused, a delay is incorporated to allow the system to defocus before it starts slewing toward a stow position. This prevents damage to the collector system from a focused beam off-track.

Face-down stow introduces some complications to the algorithms. In the embodiment shown in FIG. 1, there is only one azimuth location at which the system can be allowed to stow face-down. Therefore, when the system is commanded to stow, it is brought to the azimuth stow position with the elevation above the horizon before it is allowed to go down further. If the arm latch doesn't operate properly, or if the azimuth drive is faulted, the system is stowed face-up to avoid damage from trying to stow face-down at the wrong azimuth.

The system may run on alternative energy sources such as gas at any time, whether solar operation is enabled or not, except when the system is in a faulted condition. In local mode, gas operation is controlled by a switch closure on the local control pendant, but in other modes, gas operation is simply commanded via the SCADA system.

### SYSTEM EXAMPLE

The following example of an embodiment of the invention is provided for illustration.

Referring again to FIG. 1, multiple solar collector systems 44 may be connected to a serial network over which commands are received from the operator terminal 35 and status information is transmitted to the operator terminal 35 from multiple solar collector systems 44. Serial data transmission is provided.

Stirling Engine Communications

A dedicated serial connection connects the dish controller and the Stirling engine controller. A serial connection comes from the Stirling engine controller and is connected to the computer network 39 at the user station 33. Electrical isolation between the Stirling engine controller and the dish system controller and the dish controller and the serial link to the Stirling computer network 39 is provided.

Electrical Power Input

The solar collector system 44 accepts and supplies alternating current (“AC”) power as follows:

| | | | | Phase | |
|---|---|---|---|---|---|
| Nominal | Low Limit | High Limit | Frequency | Rotation | Current |
| 460 VAC | 368 VAC | 529 VAC | 57-63 Hz | A-B-C | 30 A |
| | | | | | nominal |

The grid protection panel 49 is equipped with relays that will disconnect the system from the grid if the voltage, frequency, or phase rotation deviate from proper values. The grid protection box shall also disconnect if the current to or from the solar collection system 44 exceeds 45A per system (I 50% of 30A nominal current).

Input Controls

The basic commands from the user are as follows:

Enable/disable solar operation

Set solar operation mode (calculated sun tracking, sun tracking using sun sensor, tracking to peak power output)

Enable/disable operation on fuel

Change system parameters (including clock updates)

Outputs and Indicators

A serial network carries all operational outputs from the dish controllers in the network. The dish controller stores data about system operation on a five-minute basis that can be downloaded by the user at user terminal 35. Similarly, the network controller stores weather data, including wind speed and direction and allow that data to be downloaded by the user. The dish and network controller also provide their current status in real time upon request by the user or user interface program at the user terminal 35.

Manual Controls and Indicators

For debugging and other purposes, manual controls are provided as follows:

Manual “Scram” button on the outside of the control box and near the operator's console, which disconnects power to the drive motors, focusing device, and gas solenoid valve

Manual 115 VAC circuit breakers accessible from outside the power box, to individually control the following components:

Azimuth drive motor power

Elevation drive motor power

Focusing device power

Gas solenoid

Scram contactor

General-purpose outlet

Power to uninterruptible power supply

Uninterruptible power supply output to Stirling engine system

Uninterruptible power supply output to dish control system

Manual dish movement system that bypasses and disconnects the dish controller outputs and allows the dish to be moved manually using a control pendant with hand switches for the azimuth and elevation motors. The manual control pendant will also include switches for the scram contactor, the focusing device 21, a speed control relay (for future use), and the gas solenoid switch for test purposes.

Manual 460VAC disconnect switch accessible from the outside of the power box to turn off the power supply from the utility grid 49 to the power box 27.

Modes of Operation

The solar collector system is capable of being operated in solar or gas operating modes, or if both are disabled, the system shall proceed to face-down stow and remain there. In solar mode, the system functionsautomatically when the sun elevation exceeds a set value, track the sun using either a sun-sensor or calculated sun position, and will focus and produce power in response to the level of insolation. The system stows automatically if high winds occur and are detected, or at the end of the day when the sun goes down. If gas operation is enabled, the system will operate using fuel within a defined period of the day (from a start time to an end time, specified by the user). If solar and gas are both enabled, then during the allowed gas operation period the system will operate on gas whenever the solar insulation is insufficient for focusing and solar operation.

Alarms/Faults

When the system detects a fault condition, it performs one or more of the following actions, depending on the type of fault. Status and warning messages may be displayed on the screen of the user interface computer. The system may cease all solar and gas operation and stow itself upon detecting a fault condition, and remains idle in a stowed position until operation is re-enabled by the operator. If the system is operating on-sun at the time of the fault, it will continue to track during the defocus delay period, then proceed to downward stow, i.e., a position where the collector surface faces the ground/earth in a face down arrangement. If the fault is in one of the drive motors the system will not try to operate the faulted motor, but will move to a safe position if it can (face-up/face-down or feathered to the wind). In case of a high-wind condition, the system will stow face-up and feathered 90 degrees to the wind, or will return to face-down stow if that position is closer.

TABLE 2
summarizes the fault responses of the system.

| Fault: | Response: |
|---|---|
| Any, except high | Stop running on gas; disable solar operation; defocus, |
| wind | then stow |
| High Wind | Stow face-up, feathered 90 degrees to wind (unless |
| | below horizon to start with); continue to run on gas |
| | if enabled |
| Azimuth Motor | Stow face-up at present azimuth (unless at azimuth |
| | stow position) |
| Elevation Motor | Move to azimuth stow position at present elevation |

As would be understood by one of ordinary skill in the art, the system and method described herein and depicted in FIGS. 1-5 is an example of a solar collection system. Alternative embodiments of such a solar collection may be implemented without departing from the essential characteristics or the spirit of the invention.

Having thus described the invention, the same will become better understood from the appended claims in which it is set forth in a non-limiting manner.

1. A method for controlling a solar collector, comprising:
receiving inputs from one or more sensors in and around the solar collector;
determining the state of the solar collector from the inputs;
receiving a command from an external source for controlling operation of the solar collector; and
executing instructions to complete the command based on the state of the solar collector.

2. The method of claim 1, wherein the commands are entered into a computer by a user.

3. The method of claim 1, wherein said receiving a command further comprises:
deriving commands based on the sensor inputs.

4. The method of claim 1, further comprising:
if the state of the solar collector is not a known state corresponding with the command; executing default instructions to place the solar collector in a default position.

5. The method of claim 1, further comprising:
if the state of the solar collector is not a known state corresponding with the command, issuing an error message.

6. The method of claim 1, further comprising:
shutting off system operations if one or more fault conditions are detected.

7. A system for controlling a solar collector, comprising:
a solar collector system for converting solar energy into usable energy, wherein said solar collector system is connectable to an energy conversion device;
a focusing device operatively connected to said solar collector system for focusing the solar energy;
one or more sensors located on or around said solar collector system;
one or more motor assemblies in communication with said solar collector system for positioning said solar collector system;
a microprocessor configured for receiving inputs from said sensors, determining the state of the solar collector from the inputs, receiving a command from an external source, and executing instructions to complete the command based on the state of the solar collector;
a power box in communication with said solar collector system and said computer system, wherein said power box comprises:
a device for monitoring the power output of the solar collector system;
a dish controller including inputs connectable to said sensors, an input connectable to said device for monitoring power output of the solar collector system; a communication cable for exchanging information between said dish controller and said computer system, and outputs;
an output board in communication with said dish controller including outputs to said motor assemblies and outputs to said focusing device;
one or more uninterruptible power supplies for powering controls to a device for storing the usable energy and said dish controller; and

8. The system of claim 7, wherein said sensors comprise at least one of a sun sensor and a horizontal reference sensor.

9. The system of claim 7, wherein the energy conversion device comprises a Stirling engine.

10. The system of claim 7, wherein the energy conversion device comprises a solid state device connectable to a battery.

11. The system of claim 7, wherein said power box includes a transformer.

12. The system of claim 7, wherein said microprocessor is a programmable logic controller (“PLC”) on said dish controller.

13. The system of claim 7, wherein said power box includes a device for power surge protection.

14. The system of claim 7, wherein said power box includes an inverter device for inverting direct current electrical power to alternating current.
